(19) United States
(12) Patent Application Publication
(10) Pub. No.: US 2019/0086017 A1
(43) Pub. Date: Mar. 21, 2019

(54) TOOLS AND METHODS FOR SETTING A PLUG INSIDE A PIPE

(71) Applicant: NuWave Industries Inc., Marwayne (CA)

(72) Inventors: Troy Illingworth, Dewberry (CA); Tim Sharp, Marwayne (CA); Mark Nekurak, Drayton Valley (CA); Marlin Belanger, Drayton Valley (CA); Ian Hambrook, Edmonton (CA); Justin Harris, Drayton Valley (CA)

(21) Appl. No.: 16/133,872

(22) Filed: Sep. 18, 2018

Related U.S. Application Data
(60) Provisional application No. 62/560,918, filed on Sep. 20, 2017.

(51) Int. Cl. F16L 55/11; B23P 19/06

(52) U.S. Cl. CPC F16L 55/1141; B23P 19/066

(57) ABSTRACT

Devices for setting a plug in a pipe, as well as methods of setting a plug using such devices, are provided. Such devices may include: a plug adaptor configured for coupling with the plug; a plug setting tool configured for engagement with the plug to actuate the plug; a motor in communication with the plug setting tool, the motor configured to actuate the plug setting tool; a control cable in communication with the motor for controlling operation thereof; and a supporting member directly or indirectly supporting the plug adaptor, the supporting member configured for positioning the plug in the pipe.

### RELATED APPLICATION

This application claims priority to U.S. patent application Ser. No. 62/560,918 filed Sep. 20, 2017, the entire contents of which are hereby incorporated by reference.

### FIELD OF INVENTION

The present invention relates generally to setting plugs in pipes. More specifically, the present invention relates to devices and methods for setting a plug in pipelines and the like.

### BACKGROUND

Pipes, pipe networks, and pipelines are used extensively for transporting liquids, slurries, fluids and gases. In the energy sector, for example, pipes and pipelines are used extensively in the recovery and transport of natural resources and products refined therefrom, including oil and natural gas. Pipes and pipelines are also used extensively in water and wastewater transport, for example.

On occasion, such pipes and pipelines must be plugged to allow for maintenance or decommissioning. Plugging may be either temporary, or permanent. By way of example, temporary plugging may be desired when performing maintenance on a section of a pipeline, while permanent plugging may be desired when decommissioning a pipeline or abandoning a well. Plugging may also be performed where diversion of the flow within the pipe into a branching line is desired, for example.

As pipes and pipelines often traverse poorly accessible terrain and/or are buried deep beneath the ground, insertion of plugs can be quite difficult. Typically, it is necessary to remove obstructions, structures, or a wide variety of other physical barriers that often prevent access. Such barriers may include earth overburden for buried pipes, buildings or other structures, mechanical equipment, roadways, etc. Controlling or diverting pipe flow often requires modification to the pipe. These issues of access and control can take time to perform, often affect other non-related equipment or operations, and may result in costly changes to the pipes themselves. Traditionally, sections of pipe have been exposed by excavation so as to allow access for plug insertion. These operations complicate maintenance and decommissioning operations, are both costly and time consuming, and can have a negative and harmful impact on the environment.

Furthermore, pipes and pipelines may span great distances, and often include bends and/or S-curves, which can impede insertion of a plug therein.

Alternative, additional, and/or improved tools and methods for setting a plug in a pipe are desirable.

### SUMMARY OF INVENTION

Setting a plug in a section of pipe can be difficult and/or costly, particularly where the section of pipe is difficult to access or buried deep underground. Provided herein are devices and methods for remotely setting a plug in a pipe, which allow the plug to be set remotely using a device which can optionally be subsequently withdrawn from the pipe. Such devices and methods can allow for remote plugging of pipes and/or control or diversion of pipe flow, for example.

In an embodiment, there is provided herein a device for setting a plug in a pipe, the device comprising:
a plug adaptor configured for coupling with the plug;
a plug setting tool configured for engagement with the plug to actuate the plug;
a motor in communication with the plug setting tool, the motor configured to actuate the plug setting tool;
a control cable in communication with the motor for controlling operation thereof; and
a supporting member directly or indirectly supporting the plug adaptor, the supporting member configured for positioning the plug in the pipe.

In another embodiment of the above device, the device may further comprise a gearbox between the motor and the plug setting tool.

In still another embodiment of the above device or devices, the motor may be a hydraulic motor and the control cable may supply a hydraulic fluid to the motor. In another embodiment of the above device or devices, the motor may be an electric motor and the control cable may supply electrical energy to the motor.

In yet another embodiment of the above device or devices, the plug setting tool may be configured to actuate the plug from a non-deployed state to a deployed state, thereby plugging the pipe; to actuate the plug from a deployed state to a non-deployed state, thereby unplugging the pipe and allowing removal of the plug from the pipe; or both.

In still another embodiment of the above device or devices, the device may be detachable from the plug once the plug is set in the pipe.

In another embodiment of the above device or devices, the device may be attachable to a plug which is already set in a pipe.

In still another embodiment of the above device or devices, the device may further comprise a camera providing visual information to assist with plugging and/or unplugging the pipe during use of the device.

In another embodiment of the above device or devices, the plug may be a compression plug having a top plate and a bottom plate with a compressible plugging material therebetween, and the plug setting tool is configured to actuate the plug from a non-deployed state to a deployed state by causing the top and bottom plates to approach one another, thereby compressing the compressible plugging material causing the compressible plugging material to expand outwardly to set the plug within the pipe.

In still another embodiment of the above device or devices, the plug may be a compression plug having a top plate and a bottom plate with a compressible plugging material therebetween, and the plug setting tool is configured to actuate the plug from a deployed state to a non-deployed state by causing the top and bottom plates to move away from one another, thereby decompressing the compressible plugging material causing the compressible plugging material to contract inwardly to unset the plug.

In another embodiment of the above device or devices, the plug adaptor may be releasable, and configured for reversible attachment with the plug by reversibly engaging one or more corresponding attachment elements of the plug and the plug adaptor.

In yet another embodiment of the above device or devices, the corresponding attachment elements may comprise one or more locking clips; pins with slots formed therein and corresponding holes; pins with expanded heads and corresponding keyhole slots; magnets and corresponding regions of magnetically attracted material or corresponding magnets; or any combination thereof.

In another embodiment of the above device or devices, the plug adaptor may be configured for reversible attachment with the plug by reversibly engaging one or more locking clips extending from the top plate of the plug, the plug adaptor, or both, and the plug adaptor being removable from the plug by withdrawing the device from the pipe while the plug is set in the pipe causing the one or more locking clips to detach.

In another embodiment of the above device or devices, the one or more locking clips may comprise a pin with a slot formed therein, and the one or more locking clips may be engagable through one or more corresponding holes, and wherein the plug adaptor may be attachable to the plug by spreading the slots while the pins are passing through the holes, and removable from the plug by pulling the device away from the plug while the plug is set in the pipe causing the slots to narrow.

In still another embodiment of the above device or devices, the corresponding attachment elements may comprise one or more pins with expanded heads and corresponding keyhole slots having locking and unlocking portions, and wherein the adaptor may be attachable to the plug by inserting the pins with expanded heads into the keyhole slots through the unlocking portions and rotating the pins with expanded heads into the locking portions of the keyhole slots, and removable from the plug by rotating the pins with expanded heads back into the unlocking portions of the keyhole slots and withdrawing the pins with expanded heads out of the keyhole slots.

In another embodiment of the above device or devices, the corresponding attachment elements may comprise one or more magnets and corresponding regions of magnetically attracted material or corresponding magnets, and wherein the plug adaptor may be attachable to the plug by engaging the magnets with the regions of magnetically attracted material or corresponding magnets, and removable from the plug by disengaging the magnets or changing the alignment of the magnets to repel the corresponding magnets

In another embodiment of the above device or devices, the device may further comprise a control module comprising:
a control cable reel for controlling feed of the control cable;
a supporting member reel for controlling feed of the supporting member; and
a controller which operates the control cable reel and the supporting member reel, the controller configured to maintain substantially equal feed rate between the control cable and the supporting member.

In another embodiment of the above device, the control module may further comprise a power system for supplying the motor with energy to operate via the control cable.

In yet another embodiment of the above device or devices, the control module may further comprise a supporting member tensioner for preventing slack on the supporting member reel.

In another embodiment of the above device or devices, the controller of the control module may be configured to track feed of the control cable and/or supporting member, thereby providing a measure of the plug positioning within the pipe during use.

In still another embodiment of the above device or devices, the control module may comprise an electrical encoder which records rotation of one or both reels, thereby tracking feed of the control cable and/or supporting member to provide a measure of the plug positioning in the pipe during use.

In another embodiment of the above device or devices, the supporting member reel may control positioning of the plug within the pipe by dispensing or retracting the supporting member.

In yet another embodiment of the above device or devices, the torque exerted by the plug setting tool on the plug during actuation thereof may be regulated by the control module, allowing control over the tension of the plug.

In another embodiment of the above device or devices, the torque exerted by the plug setting tool on the plug during actuation thereof may be tracked by the control module and displayed to a user.

In still another embodiment of the above device or devices, the control module may further comprise a user interface providing controls for operating the device and displaying information concerning plug positioning and/or deployment status.

In another embodiment of the above device or devices, the supporting member may comprise a spring strip. In certain embodiment, the supporting member may comprise a spring steel strip.

In another embodiment, there is provided herein a use of the device or devices above for setting a plug in a pipe.

In still another embodiment, there is provided herein a method of setting a plug in a pipe using a device as defined above, said method comprising:
providing the device as defined above with a plug attached thereto;
inserting the plug into the pipe at a desired location along the pipe by feeding a corresponding length of the supporting member into the pipe so as to position the plug at the desired location; and
activating the motor to actuate the plug setting tool to actuate the plug from a non-deployed state to a deployed state,
thereby setting the plug in the pipe.

In another embodiment of the method above, the method may further comprise detaching the plug adaptor from the plug, and withdrawing the device from the pipe by withdrawing the supporting member from the pipe.

In another embodiment of the above method or methods above, the method may further comprise feeding the supporting member back into the pipe and re-attaching the plug adaptor to the plug.

In still another embodiment of the above method or methods, the method may further comprise activating the motor to actuate the plug setting tool to actuate the plug from the deployed state to the non-deployed state, thereby unsetting the plug in the pipe.

In yet another embodiment of the above method or methods, the method may further comprise withdrawing the device and the plug from the pipe by withdrawing the supporting member from the pipe.

In another embodiment, there is provided herein a method of setting a plug in a pipe using a device as defined above, said method comprising:
providing a device as defined above with a plug attached thereto;
inserting the plug into the pipe at a desired location along the pipe by feeding a corresponding length of the supporting member into the pipe using the supporting member reel so as to position the plug at the desired location; and
activating the motor to actuate the plug setting tool to actuate the plug from a non-deployed state to a deployed state,
thereby setting the plug in the pipe.

In another embodiment of the above method, the method may further comprise detaching the plug adaptor from the plug, and withdrawing the device from the pipe by withdrawing the supporting member from the pipe using the supporting member reel.

In another embodiment of the above method or methods, the method may further comprise feeding the supporting member back into the pipe using the supporting member reel and re-attaching the plug adaptor to the plug.

In yet another embodiment of the above method or methods, the method may further comprise activating the motor to actuate the plug setting tool to actuate the plug from the deployed state to the non-deployed state, thereby unsetting the plug in the pipe.

In another embodiment of the above method or methods, the method may further comprise withdrawing the device and the plug from the pipe by withdrawing the supporting member from the pipe using the supporting member reel.

### BRIEF DESCRIPTION OF DRAWINGS

FIG. 1 shows a perspective view of an embodiment of a device for setting a plug in a pipe as described herein;

FIG. 2 shows a cross-sectional profile view of the embodiment of the device for setting a plug in a pipe of FIG. 1;

FIG. 3 shows (A) perspective view of an embodiment of a plug as described herein featuring pins with expanded heads; (B) a perspective view of an embodiment of a plug adaptor as described herein featuring keyhole slots as described herein; and (C) a front view of the plug adaptor embodiment of (B);

FIG. 4 shows (A) a perspective view of an embodiment of a device for setting a plug in a pipe as described herein in locked position with a plug; (B) a perspective view of the device and plug depicted in (A) in unlocked position; and (C) a perspective view of the device and plug depicted in (A) with the plug released from the plug adaptor;

FIG. 5 depicts another embodiment of a device for setting a plug in a pipe as described herein;

FIGS. 6-8 depict the device of FIG. 5, providing views of the plug setting tool;

FIG. 9 shows a side view of another embodiment of a device for setting a plug in a pipe as described herein, which includes a control module; and

FIG. 10 shows a perspective view of the device of FIG. 9, providing a detailed view of the control module.

### DETAILED DESCRIPTION

Described herein are devices and methods for setting a plug in a pipe. It will be appreciated that embodiments and examples are provided for illustrative purposes intended for those skilled in the art, and are not meant to be limiting in any way.

In certain embodiments, a remotely operated device for setting a plug in a pipe is provided. Such devices may be inserted into a pipe or tube, and positioned using a supporting member (such as, for example, a spring strip) of variable length. The supporting member may be used to transport a plug in connection with the device long distances through a pipe to a desired location. In certain embodiments, the plug may be set, deployed, or fixed into the desired location using a remotely operated control module or system of the device, which controls feed of the supporting member. In certain embodiments, once the operation of seating the plug is performed, the device may be removed from the pipe. As well, in certain embodiments, the tool may be re-inserted into the pipe containing the previously deployed plug (or into a different pipe containing a different deployed plug), and used to release and withdraw the plug from the pipe. In certain further embodiments, a camera system may be used to assist the operator in deploying and/or removing plugs.

In an embodiment, there is provided herein a device for setting a plug in a pipe, the device comprising:
a plug adaptor configured for coupling with the plug;
a plug setting tool configured for engagement with the plug to actuate the plug;
a motor in communication with the plug setting tool, the motor configured to actuate the plug setting tool;
a control cable in communication with the motor for controlling operation thereof; and
a supporting member directly or indirectly supporting the plug adaptor, the supporting member configured for positioning the plug in the pipe.

As will be understood, the pipe in which the plug is set may be any suitable pipe for which temporary or permanent plugging or capping may be desired. In certain embodiments, the pipe may be a pipe for which plugging is desired as part of pipeline abandonment and/or repair; containment of hazardous substances in a damaged pipe at an industrial operation; municipal water and/or sewer system modification/repair; public buildings, apartments, or high-rises having difficult to access systems in need of repair and/or modification; and/or HVAC system repair, for example. Pipes may include, for example, pipelines, pipe networks, production well or injection well piping, or other pipes which may be used to carry any of a variety of different liquids, slurries, fluids and/or gases which may or may not be under pressure or vacuum. By way of example, the pipe may be part of a pipeline which transports oil or natural gas. Pipes may be linear or straight, or may include bends or curves, or pipeline riser sections, for example.

As will also be understood, the plug adaptor may include any suitable adaptor or fitting which can be used to couple with the plug to be set. The plug adaptor may be permanently joined with the plug, or may be detachable from the plug, depending on the operations to be performed. The plug adaptor may be coupled with the plug using any suitable attachment mechanism known to the person of skill in the art, and is not limited to the particular examples described in further detail hereinbelow. The plug adaptor of the device may include any suitable adaptor which may be joined with the plug. Plug adaptors may include any suitable clip, snap, buckle, pin, male-female, magnetic, friction fit, weld, bond, or other fitting which will be known to the person of skill in the art having regard to the teachings provided herein. The role of the plug adaptor is to join the plug with the device, and support the plug during setting of the plug. In embodiments where detachment of the device from the plug is desired, the adaptor may be releasable, whereby attachment of the adaptor to the device can be reversed (i.e. detached).

As will be understood, the skilled person having regard to the teachings provided herein will be aware of several different configurations suitable for attaching the plug adaptor to the plug. By way of example, where a reversible attachment is desired, the plug adaptor of the device may be a releasable plug adaptor, and may be configured for reversible attachment with the plug by reversibly engaging one or more corresponding attachment elements of the plug and the plug adaptor. In certain embodiments, the corresponding attachment elements may comprise one or more locking clips extending from the top plate of the plug (or from the plug adaptor), the plug adaptor being removable from the plug by withdrawing the device away from the plug while the plug is set in the pipe causing the one or more locking clips to detach.

In yet other embodiments, the corresponding attachment elements may comprise one or more locking clips which may each comprise a pin with a slot formed therein, and the one or more locking clips may be accommodated through one or more corresponding holes, and the plug adaptor may be attachable to the plug by spreading the slots while the pins are passing through the holes, and removable from the plug by pulling the device away from the plug while the plug is set in the pipe causing the slots to narrow. In still further embodiments, the corresponding attachment elements may comprise one or more magnets and one or more corresponding regions of magnetically attracted material or one or more corresponding magnets, and the plug adaptor may be attachable to the plug by engaging the magnets with the regions of magnetically attracted material or corresponding magnets, and removable from the plug by disengaging the magnets or changing the alignment of the magnets to repel. In still further embodiments, the corresponding attachment elements may comprise one or more pins with expanded heads and one or more corresponding keyhole slots having locking and unlocking portions, and the plug adaptor may be attachable to the plug by inserting the pins with expanded heads into the keyhole slots through the unlocking portion and rotating the pins with expanded heads into the locking portion of the keyhole slots, and removable from the plug by rotating the pins with expanded heads back into the unlocking portion of the keyhole slots and withdrawing the pins with expanded heads out of the keyhole slots.

As will be understood, various configurations of the corresponding attachment elements with respect to the plug adaptor and the plug are possible and contemplated herein. The person of skill in the art having regard to the teachings herein will understand that various compatible plug/plug adaptor designs may be possible, and selectable based on the particular plugging application. An example of a plug adaptor, in this case a releasable plug adaptor, may include two drilled holes for reversible engagement with a plug via locking clip pins extending from the top plate of an example of a plug, as described in further detail below.

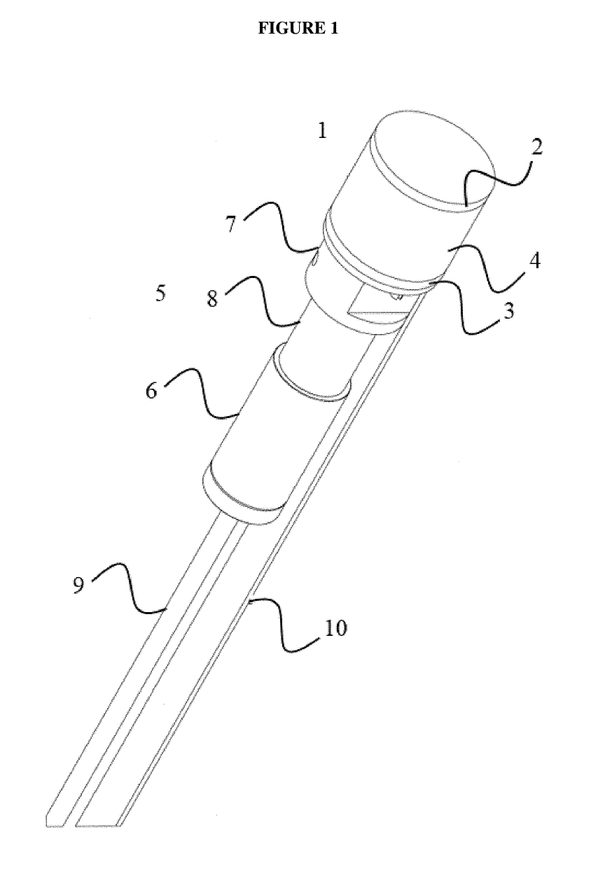

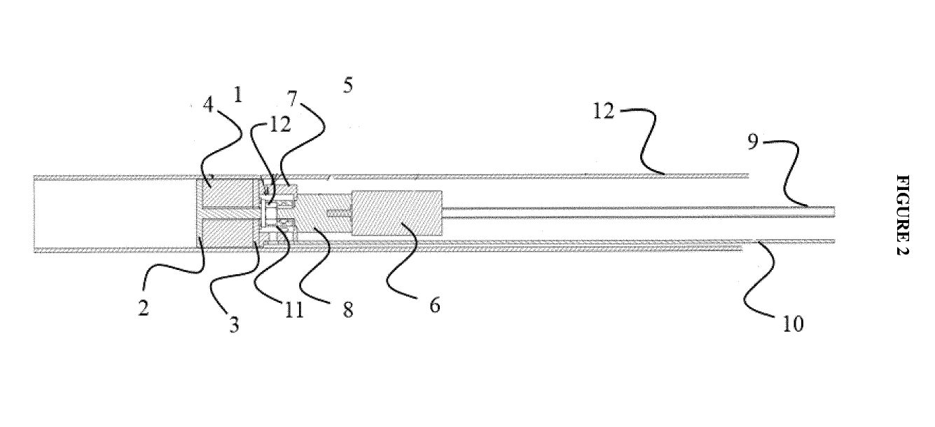

In the plug embodiment depicted in FIGS. 1 and 2, the plug adaptor (7) of the device embodiment reversibly joins with the plug (1) by accommodating one or more locking clips extending from the top plate (3) of the plug (1). The exemplified plug adaptor (7) is removable from the plug (1) by withdrawing the device away from the plug (1) while the plug (1) is set in the pipe, which causes the one or more locking clips to detach from the plug adaptor (7). In the certain embodiments, the one or more locking clips may comprise a pin or rod with a slot formed therein, and the one or more locking clips may be accommodated by the plug adaptor (7) through one or more holes formed therein. The plug adaptor (7) is attachable to the plug (1) by spreading the slots while the pins are passing through the holes, and removable from the plug (1) by pulling the device (5) away from the plug (1) while the plug (1) is set in the pipe which causes the slots to narrow allowing the locking clips to exit the holes in the plug adaptor (7).

It will be understood that, in certain embodiments, it may be desirable that the plug remain joined to the device, without becoming separated therefrom. For example, in applications where temporary plugging is needed, it may be desirable to maintain attachment so as to allow for the plug to be inserted into the pipe and set by the device, and then subsequently unset and withdrawn from the pipe by the device without the device becoming detached therefrom.

As such, in certain embodiments, the plug adaptor of the device may include a fitting which does not release, or which is fused, joined, or attached, with the plug. Thus, in certain embodiments, the releasable nature of the plug adaptor may be optional. By way of example, securing the plug (1) to the plug adaptor (7) using nuts tightened along bolts, would provide a device which remains secured to the plug during use, and which would allow plug insertion, setting, unsetting, and removal from a pipe without occurrence of detachment of the plug from the device.

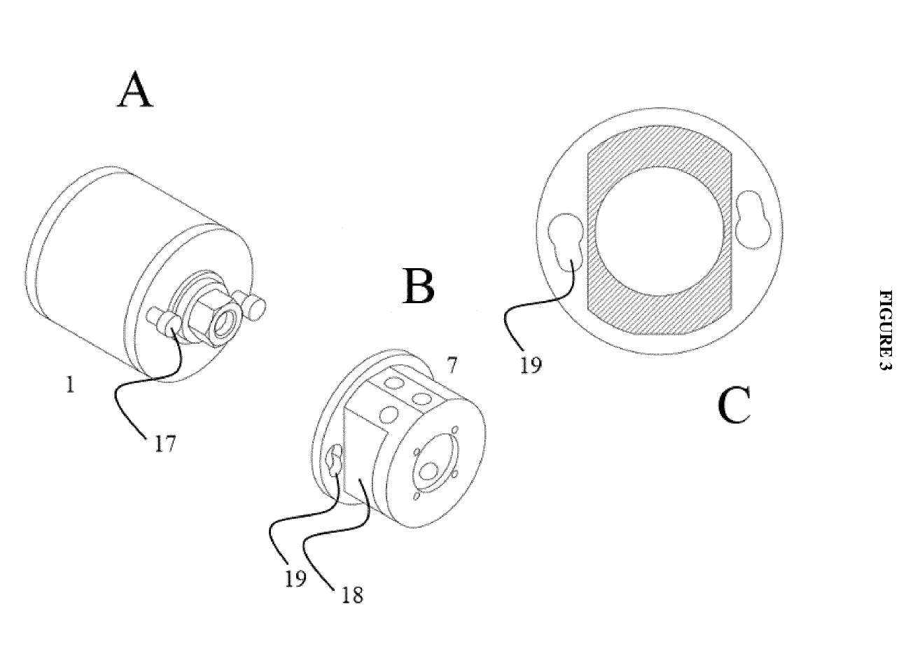

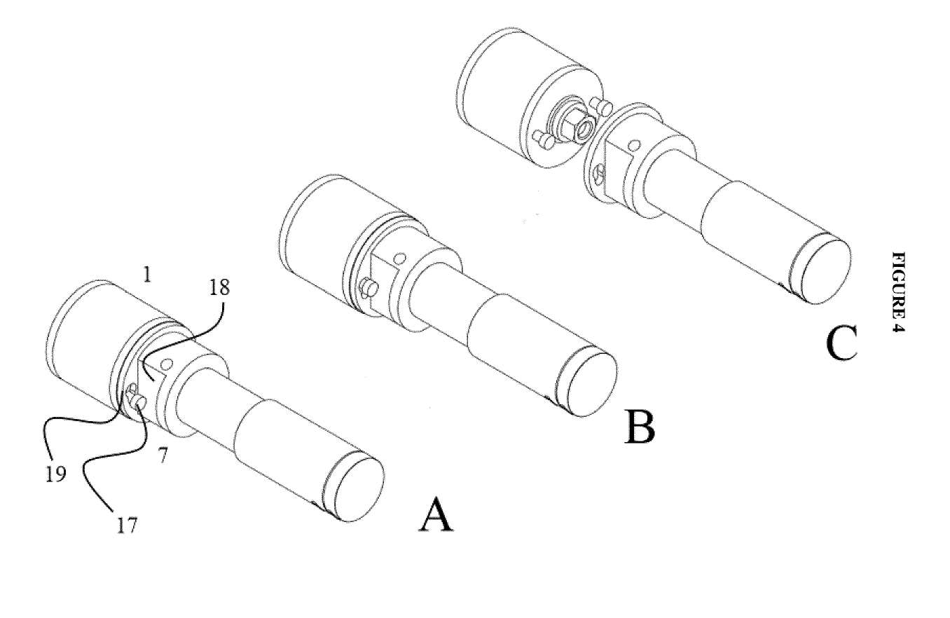

As will be understood, the device may optionally be detached from the plug and then subsequently re-attached to the plug. Such an optional step may be desirable where, for example, a maintenance operation is to be performed after the plug is set which is more easily accomplished with the device removed from the pipe. In such embodiments, a corresponding attachment element configuration between the plug adaptor and the plug, as described hereinabove, may be used for the optional detachment and subsequent re-attachment steps. For example, the pin with expanded head/keyhole configuration illustrated in FIGS. 3 and 4 may allow for such detachment and re-attachment.

The plug setting tool may be any suitable tool which is able to engage with the plug and actuate the plug (i.e. transition the plug from a non-deployed state to a deployed state thereby plugging the pipe; transition the plug from a deployed state to a non-deployed state thereby unplugging the pipe and allowing removal of the plug from the pipe; or both where the tool is to be used for both setting and unsetting a plug). In embodiments where the plug requires that a mechanical force be imparted thereto in order to set/unset, the plug setting tool may be a tool which is able to impart such mechanical force, such as rotational force (for example), to the plug. In certain embodiments, the plug setting tool may be accommodated by or integrated with the plug adaptor such that the plug setting tool may be engaged with the plug when the plug adaptor is coupled to the plug. Where the plug setting tool is configured to impart mechanical force to the plug, the plug setting tool may be a tool which is workable by a motor to impart force/energy on the plug, thereby setting the plug in the pipe. The plug setting tool may be selected to suit particular plug design, or a particular plugging application. The plug setting tool may be, for example, a male tool or a female tool which is capable of engaging with a corresponding female or male fitting of the plug. By way of example, the plug setting tool may be a socket, bit, or hex fitting, or another suitable fitting for engaging with a corresponding member of the plug.

In embodiments where a motor is used to drive the plug setting tool, the motor may include any suitable motor known to the person of skill in the art having regard to the teachings herein. By way of non-limiting example, the motor may be an electric motor, or a hydraulic motor, for example. The motor may be configured to drive operation of the plug setting tool. In certain embodiments, the motor output may be coupled directly to the plug setting tool (or integrated therewith), or may be coupled indirectly to the plug setting tool via, for example, a gear box (such as a reducing gear box). In certain embodiments, the output torque of the motor and/or gearbox (where present) may be adjustable or selectable, such that a particular torque may be imparted to the plug so as to provide a particular tension of the plug when set in the pipe.

The control cable may be any suitable cable or other transmission means for communicating with the motor and/or supplying power thereto. By way of example, where the motor is a hydraulic motor, the control cable may supply hydraulic fluid to the motor (i.e. may comprise a hydraulic hose). In other embodiments where the motor is an electric motor, the control cable may supply electrical energy to the motor (i.e. may comprise an electrical wire). As will be understood, devices described herein may be operated remotely by a user via, for example, a control module. The control cable may maintain communication between the user/control module and the device located within the pipe during use, allowing the motor/plug setting tool to be remotely operated to set/unset the plug within the pipe. In embodiments employing a motor which requires power for operation (i.e. where the motor does not have an on-board battery, for example), the control cable may supply power to the motor. In certain embodiments, the cable may comprise more than one transmission line and may, for example, include a wire supplying electricity to the motor, and a wire supplying a control input or signal to the motor to direct operation thereof. It will be understood to the skilled person having regard to the teachings herein that various configurations may be possible. In certain embodiments, the control cable may supply power to the motor, may supply a control signal regulating operation of the motor, or both. Where the motor includes a battery, the control cable may provide a control signal; or, where the motor includes a wireless communications component which allows wireless user control, the control cable may provide power to the motor/plug setting tool. In certain embodiments, it is contemplated that the control cable may be optional or omitted, such as where the motor includes a battery and a wireless communications component. In certain embodiments, the control cable may be separate from, or integrated with, the supporting member.

The supporting member may be any suitable supporting member which may be used to directly or indirectly support the plug adaptor so as to allow positioning of the plug in the pipe. A supporting member or spring strip as referenced herein may be understood as defining any suitable supporting member which may be used to directly or indirectly support the plug adaptor so as to allow positioning of the plug in the pipe. In certain embodiments, the spring strip (i.e. the supporting member) may be windable such that it can be spooled on a reel as described in further detail herein. The spring strip (i.e. the supporting member) may be directly attached to the plug adaptor portion of the device, or to another device component which is in turn connected with the plug adaptor. The spring strip (i.e. supporting member) feeds into the pipe along with the plug adaptor, and therefore may in certain embodiments be at least partially flexible so as to allow the device to traverse pipe curves or bends (in embodiments where such obstacles are present), while still retaining sufficient structural rigidity to prevent the plug adaptor/device/plug from falling into the pipe (for vertical or substantially vertical pipes) and/or to allow the device/plug to be forced through pipe regions offering resistance as a result of curves, bends, clogging, or friction, for example. Where the plug is to be set a short distance into a straight pipe, the spring strip (i.e. the supporting member) may be as simple as a pole or rod. In certain embodiments, the spring strip (i.e. the supporting member) may comprise, or may be substituted for, a flexible cable, tubing, wire, or rod, for example. However, where the plug is to be set a long distance and/or beyond a pipe curve or bend, it may be desirable for the spring strip (i.e. the supporting member) to comprise a cable or spring steel strip, for example. As will be understood, the supporting member may have a cross-section of any suitable shape selectable by the person of skill in the art. In the examples described in further detail herein below, a steel spring strip is employed. In certain embodiments, the spring strip may be a spring strip, such as a steel spring strip, which is able to traverse pipe curves/bends while still retaining sufficient structural rigidity so as to allow positioning of the plug in the pipe (i.e. preventing the plug from falling into the pipe, and allowing the plug to be forced through resisting pipe sections), and which is able to be wound or spooled on, for example, a reel located at a control module portion of the device. Such spooling may allow the device to be more modular and transportable, while still allowing for the setting of plugs at long distances into pipes. Further, as described in additional detail below, tracking of reel rotations during feeding of the device into the pipe may allow for tracking of plug positioning within the pipe, allowing for increased accuracy and/or simplifying of plug positioning during use.

As will be also be understood, the plug may be any suitable plug which is workable by a device as described herein to plug a pipe. Several pipe plugs are known in the art which may be suitable for direct use, or which may be adaptable for use, with a device or method as described herein. In certain embodiments, the plug may be, for example, a compression plug, although other plugs may be possible and may be selectable by the person of skill in the art having regard to the teachings herein to suit a particular application. The skilled person will be aware of applicable governing regulatory board standards, if any, and will be able to select a suitable plug for a particular application accordingly.

An example of a plug is depicted in FIGS. 1 and 2. In this embodiment, the plug (1) is a compression plug (in this example, a 3 inch compression plug) having a top plate (3) and a bottom plate (2) with a compressible plugging material (4) (in this example, rubber) therebetween, and a bolt/nut (12) (in this case, a locking nut is depicted) spanning between the top (3) and bottom (2) plates. In this embodiment, the plug setting tool (11) causes the top (3) and bottom (2) plates to approach one another when the plug setting tool (11) is engaged with the bolt/nut (12) of the plug (1) and the motor (6) is used to drive the plug setting tool (11), thereby causing the nut to force the top (3) and bottom (2) plates together, causing the compressible plugging material (4) to expand radially outwardly to set the plug (1) within the pipe.

As will be understood, in certain embodiments it may be desirable that pipe plugging be accompanied by pipe cutting. By way of example, decommissioning or abandonment of a plugged oil or gas well typically involves cutting and removal of wellbore casings to a depth of two meters below the surface. As such, in certain embodiments, it is contemplated that methods and devices as described herein may be used in combination with ultra high pressure pipe cutters such as those described in U.S. Pat. No. 8,820,396, which is herein incorporated by reference in its entirety. By way of example, in certain embodiments where pipe cutting is desired, it is contemplated that a cutting tool may be attached to the supporting member of the device, and the supporting member may be used to feed the cutting tool to the desired location of the pipe where it can be operated (electrically or hydraulically, for example) to perform the rotation of the cut. In certain embodiments, it is contemplated that the cutting tool may be connectable to the supporting member of the device, the control cable of the device, or both. In certain embodiments, the pipe cutting tool may be connectable to the motor of the device, and the motor may be used to actuate the cutting tool. In certain embodiments, the device may be configured such that following setting of the plug, the device can be detached from the plug and withdrawn from the pipe, at which point the cutting tool may be attached thereto and re-inserted into the pipe such that pipe cutting may be performed. In certain embodiments, it is contemplated that the cutting tool may be attachable to the plug adaptor, attachable to the plug setting tool, attachable to the gearbox, attachable to the motor, attachable to the control cable, and/or attachable to the supporting member (i.e. spring strip) of the device. In certain embodiments, the cutting tool may be attachable to the device as-is, or may be attachable to the device once one or more device components have been removed (i.e. in certain embodiments, for example, the plug adaptor may be removed from the device to allow the cutting tool to be connected).

In still further embodiments, it is contemplated that the device may further comprise a camera directed at the plug setting tool, providing visual information on an engagement status between the plug setting tool and the plug. By way of example, a camera including a fibre optic lead extending into the pipe may be provided. In yet another embodiment, it is contemplated that the device may comprise a camera directed at the plug adaptor, the plug, or both, providing visual information on an attachment status between the plug adaptor and the plug. Such camera(s) may facilitate the optional detachment/re-attachment step described above, and/or may facilitate retrieval of another plug set in a pipe, by providing a user with information allowing the user to more easily align the fitting and/or plug setting tool with the set plug during re-attachment.

In certain embodiments, the devices described herein may comprise a control module comprising:
a control cable reel for controlling feed of the control cable;
a supporting member reel for controlling feed of the supporting member; and
a controller which operates the control cable reel and the supporting member reel, the controller configured to maintain substantially equal feed rate between the control cable and the supporting member.

In certain embodiments, the supporting member may comprise a spring strip, and the supporting member reel may comprise a spring strip reel.

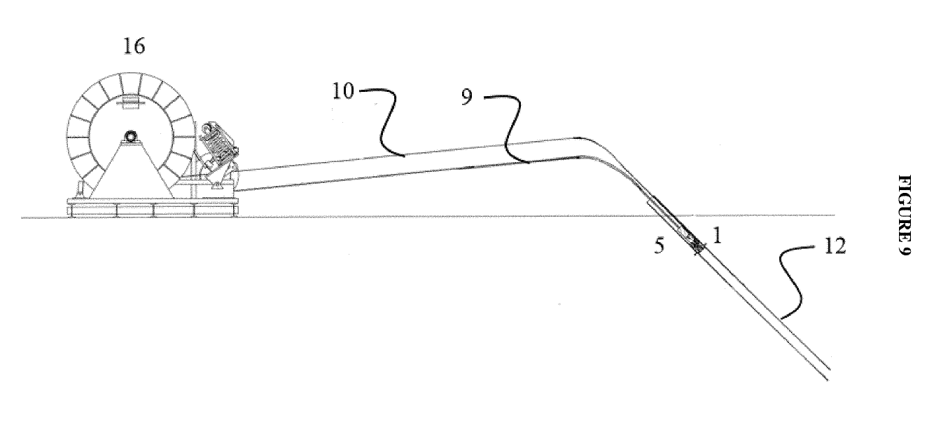

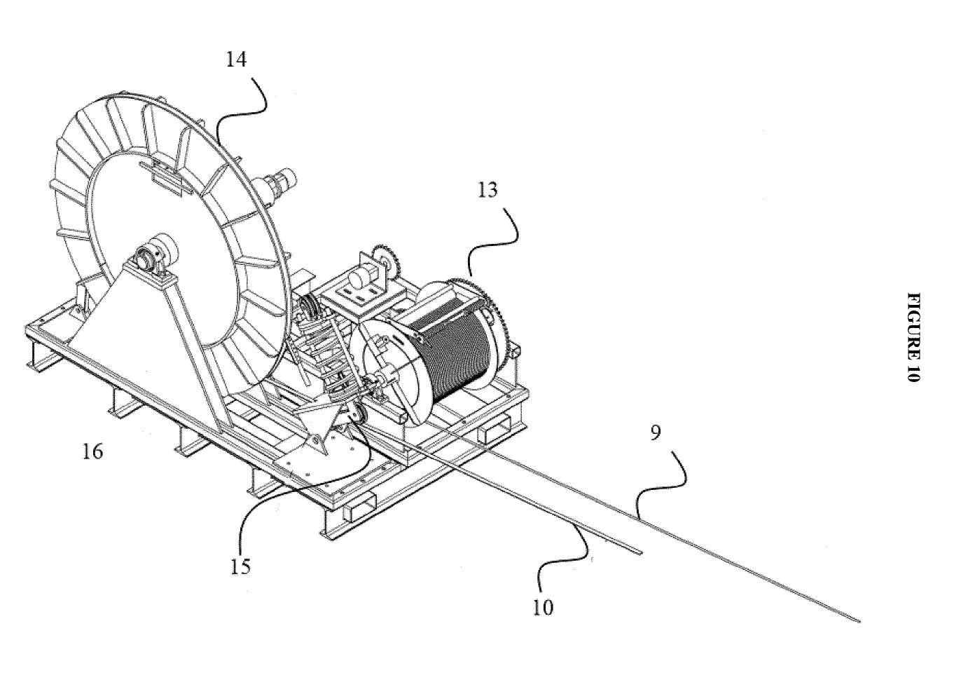

The control module may, in certain embodiments, feature a modular and/or transportable design with the various components integrated into a mobile unit. By way of example, FIGS. 9 and 10 depict a control module (16) which features the various components (control cable reel, spring strip reel, controller) configured on a skid. Other embodiments are also contemplated, such as a control module configured on a trailer, on a cart, or on a truck bed, for example.

As will be understood, in certain embodiments, the supporting member reel and the control cable reel may be separate reels, may be connected with one another, or may be integrated together (i.e. the spring strip and the control cable may be wound on a single reel acting as both a control cable reel and a spring strip reel, for example). In certain embodiments, the reels may be operated independently from one another. In certain embodiments, operation of the reels may be synchronized or otherwise co-ordinated, either physically or via the control module, so as to prevent feeding out one reel too quickly as compared to the other, thereby providing accumulation of slack.

As will be understood, the control module may facilitate operation of the device and setting of the plug in the pipe. In certain embodiments, the reels may be manually operated to position the plug in the pipe. In other embodiments, however, the controller of the control module may operate the control cable reel and supporting member reel, so as to maintain substantially equal feed rate of the control cable and supporting member into the pipe, thereby reducing slack or unnecessary strain on the cable and/or strip. The control cable may typically be more sensitive to damage (since it may carry hydraulic fluid and/or electrical connections), and therefore the controller may prevent the spring strip from feeding out too quickly so as to reduce strain on the control cable, for example. In certain embodiments, the spring strip reel may control positioning of the plug within the pipe by dispensing or retracting the spring strip during use.

In certain embodiments, the control module may further comprise a power system for supplying the motor with energy to operate via the control cable. By way of example, the control module may comprise an electrical generator, a battery, or a hydraulic system for supplying power to the motor. As will be understood, the power supply may be matched with the motor so as to apply appropriate power thereto.

In certain embodiments, the control module may be configured to track feed of the control cable and/or supporting member, thereby providing a measure of the plug positioning within the pipe during use. By way of example, in certain embodiments the control module may comprise an electrical encoder which records rotation of one or both reels, thereby tracking feed of the control cable and/or spring strip to provide a measure of the plug positioning in the pipe during use. In certain embodiments, feed of the spring strip may be used to determine device and/or plug positioning within the pipe during use, for example. In certain embodiments, the controller of the control module may be configured to track feed of the control cable and/or spring strip, thereby providing a measure of the plug positioning within the pipe during use.

In certain embodiments, the control module may further comprise a supporting member tensioner for preventing slack on the supporting member reel. Such a tensioner may be preferable in embodiments where feed of the supporting member reel, such as a spring strip reel, is tracked so as to determine plug positioning. In certain embodiments, by preventing reel slack with the tensioner, the depth of the plug and/or plug adaptor within the pipe may be closely determined, which may allow for more precise operations.

In certain embodiments, the torque or force exerted by the plug setting tool on the plug during actuation thereof may be regulated by the control module, allowing for control over the tension of the plug. By way of example, torque or force exerted by the plug setting tool on the plug when setting the plug may be applied at or above a predetermined threshold, so as to ensure that the plug is set within the pipe at or above a predetermined minimum tension desired or mandated by safety requirements.

In certain embodiments, the torque or force exerted by the plug setting tool on the plug during actuation thereof may be tracked or sensed by the control module, and may be displayed to a user. By tracking or sensing the torque or force applied, the user can be provided with an extra indicator that the plug has been properly set/unset as desired. For example, the user may be provided with a confirmation that the plug is set at a tension suitable to provide a tight and lasting seal in the pipe. Further, where the device is used to unset and retrieve a previously set plug, sensing the torque/force applied on the plug during the unsetting may provide the user with an indication that the device was properly re-attached to the plug and/or that the plug setting tool was properly re-engaged with the plug so as to allow the plug to be unset. If a user sees that the plug setting tool is not imparting force to the plug, the user may adjust the device positioning and/or actuate the plug setting tool until better alignment and coupling is achieved, for example.

In certain embodiments, the control module may comprise a user interface providing controls for operating the device and displaying information concerning plug positioning (i.e. depth within the pipe, etc. . . . ), device/plug coupling status (i.e. connection status between the plug adaptor and the plug, between the plug setting tool and the plug, etc. . . . ), and/or plug deployment status (i.e. set or unset, tension, etc. . . . ) to the user.

In certain embodiments, the control module may control operation of the motor/plug setting tool via a wired connection, or via a wireless connection, thereto.

In certain embodiments, the control module may additionally comprise on or more of the following components:
an on/off switch for main power control;
a controller for controlling rotation of the motor driving the plug setting tool to tension or loosen a plug as desired;
a display of electrical amperage and/or hydraulic pressure communicated to the motor;
controls for selecting the direction of rotation and/or speed of one or both reels; and/or
camera controls and/or a video feed from a camera when inserted into the pipe.

In certain embodiments, there is provided herein a method of setting a plug in a pipe using a device as described herein, said method comprising:
providing a device as described herein, with a plug attached thereto;
inserting the plug into the pipe at a desired location along the pipe by feeding a corresponding length of the supporting member into the pipe so as to position the plug at the desired location; and
activating the motor to actuate the plug setting tool to actuate the plug from a non-deployed state to a deployed state,
thereby setting the plug in the pipe.

In certain embodiments, the method may further comprise detaching the plug adaptor from the plug, and withdrawing the device from the pipe by withdrawing the supporting member from the pipe. Such a step may be performed where, for example, an operation to be performed on the pipe is more easily accomplished if the device is withdrawn or partially withdrawn from the pipe.

Where the plug is to be subsequently unset and/or retrieved, the method may further comprise a step of feeding the supporting member back into the pipe and re-attaching the plug adaptor to the plug. Alternatively, the device may be inserted into a different pipe containing a set plug, and the plug adaptor may be attached to the set plug.

In certain embodiments of methods described hereinabove, the method may further comprise activating the motor to actuate the plug setting tool to actuate the plug from the deployed state to the non-deployed state, thereby unsetting the plug in the pipe. The device and the plug may then be withdrawn from the pipe by withdrawing the supporting member from the pipe.

In certain embodiments, there is provided herein a method of setting a plug in a pipe using a device as defined herein, said method comprising:
providing a device as described herein, with a plug attached thereto;
inserting the plug into the pipe at a desired location along the pipe by feeding a corresponding length of the supporting member into the pipe using a supporting member reel so as to position the plug at the desired location; and
activating the motor to actuate the plug setting tool to actuate the plug from a non-deployed state to a deployed state,
thereby setting the plug in the pipe.

In certain embodiments, the method may further comprise detaching the plug adaptor from the plug, and withdrawing the device from the pipe by withdrawing the supporting member from the pipe using the supporting member reel. Such a step may be performed where, for example, an operation to be performed on the pipe is more easily accomplished if the device is withdrawn or partially withdrawn from the pipe.

Where the plug is to be subsequently unset and/or retrieved, the method may further comprise a step of feeding the supporting member back into the pipe using the supporting member reel and re-attaching the plug adaptor to the plug. Alternatively, the device may be inserted into a different pipe containing a set plug using the supporting member reel, and the plug adaptor may be attached to the set plug.

In certain embodiments of methods described hereinabove, the method may further comprise activating the motor to actuate the plug setting tool to actuate the plug from the deployed state to the non-deployed state, thereby unsetting the plug in the pipe. The device and the plug may then be withdrawn from the pipe by withdrawing the supporting member from the pipe via the supporting member reel.

It will be understood that withdrawal of the device from the pipe is typically accomplished by withdrawing the supporting member. However, in certain embodiments, it is contemplated that the control cable, and connection(s) between the control cable and the downhole portion of the device, may be re-enforced such that withdrawal of the control cable may be used to withdraw the device from the pipe, or to assist the supporting member with withdrawal of the device from the pipe. Since the control cable may typically be more sensitive to damage (since it may carry hydraulic fluid and/or electrical connections) than the supporting member, it may be desirable that the supporting member be used to withdraw the device at least in certain examples where pipe conditions resist withdrawal of the device.

As will be understood, in certain embodiments of the devices and methods described hereinabove, the supporting member may comprise a spring strip.

### Examples

The following examples are provided for illustrative purposes intended for the person of skill in the art. As will be understood, various substitutions, modifications, or other changes in configuration may be made to suit particular applications.

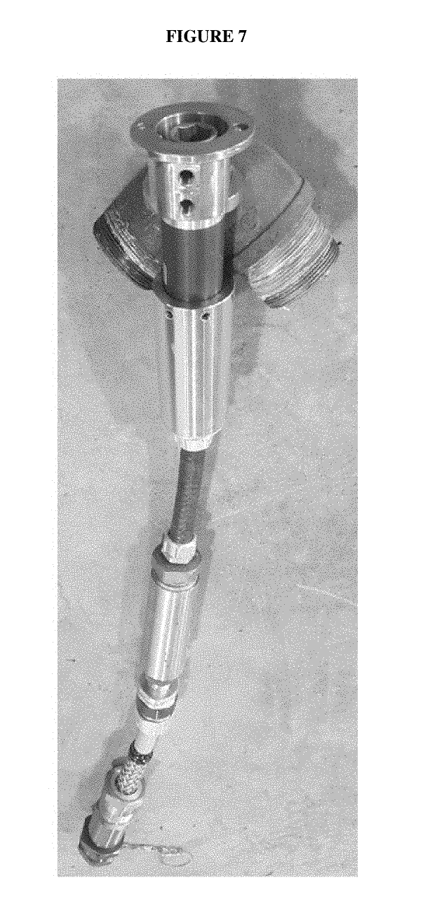

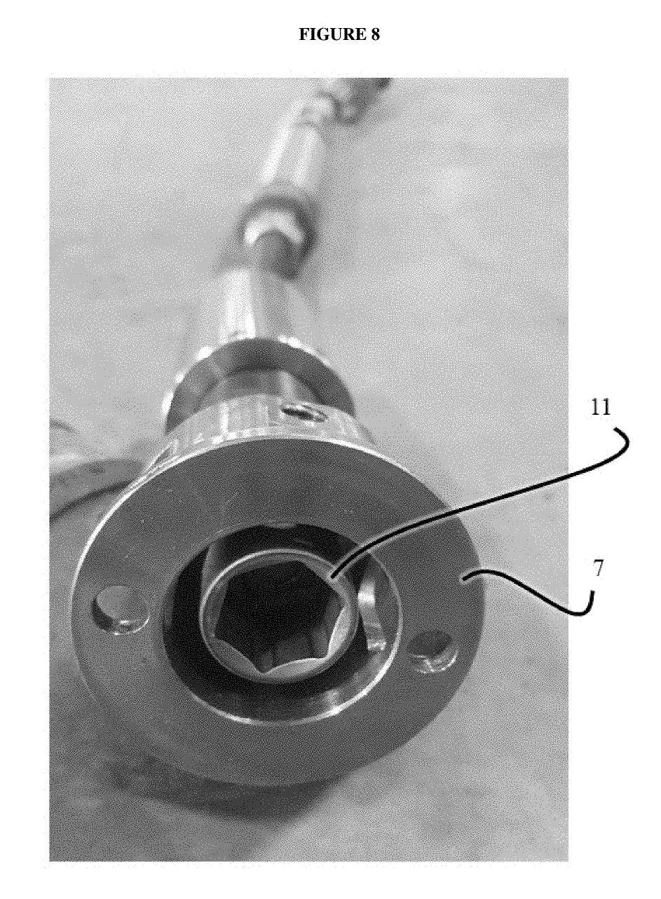

FIGS. 1-10 depict embodiments of remotely operated devices for setting a plug in a pipe as described herein. The illustrated device embodiments include: a device portion which is insertable into a pipe and which includes a remotely operated plug setting tool and a plug adaptor which holds the plug; a long spring steel strip that positions the device/plug in the pipe at a desired position; a long control cable which operates the plug setting tool; a control module comprising a skid with reels and controls to store the steel strip, control cable, and operate the device. During use, a mechanically expanding plug may be mounted to the plug adaptor. The device includes a plug adaptor, gearbox, and driving motor. The motor and gearbox are configured to rotate a nut on the plug that expands or contracts it by turning clockwise or counter clockwise. The motor may be either electrically or hydraulically operated through the control cable. The force applied to the nut may be varied by the control to the motor and gearbox so as to properly set the plug at its correct tension and be securely located.

The tool may be connected via a control cable and a spring steel strip to a reels skid assembly. This assembly may store the control cable and spring steel strip on reels, and may house the controls and power system. The reels may be configured to manage the position of the plug setting tool by way of an electrical encoder that records the rotation thereof. A reel tensioner may be used to maintain uniform winding of the spring steel strip onto the reel so as to maintain accuracy of recording the length of the strip fed into the pipe during use. The control system may operate the power and hydraulic (or electric) system, operate the reels for the control cable and steel strip, operate the device components in the pipe, and may record position of the tool and/or operating processes performed during use.

In operation, an operator may extend the steel strip and control cable attached to the portion of the device entering the pipe, and position the tool at an opening or open end of a pipe or tube. The reels may then extend the steel strip and control cable into the pipe or tube until the plug reaches the desired location (which may be determined, at least in part, by monitoring the length of spring strip and/or control cable being reeled out). The operator may then activate the motor and gearbox of the device, so as to actuate the plug setting tool to engage an expanding nut on the plug to be set. The controller of the control module may limit or control (and display) the torque applied to the nut, so as to set the plug at a desired tension or within a desired tension range. When the tightening operation is completed, the operator may withdraw the device from the pipe by rewinding the steel strip and control cable onto the reels.

An example of a device for setting a plug in a pipe as described herein is depicted in FIGS. 1 and 2, where a device (5) for setting a plug in a pipe (12) is shown attached to a plug (1). The plug in this example is a compression plug comprising a bottom plate (2), a top plate (3), a compressible plugging material (4) therebetween, and a plug nut (12), whereby tightening of plug nut (12) causes the top plate (3) and the bottom plate (2) to approach one another, compressing the plugging material (4) and causing the plugging material (4) to expand outwardly so as to plug the pipe.

The device (5) depicted in FIGS. 1 and 2 includes a plug adaptor (7) which is coupled with the plug (1), and a plug setting tool (11) in the form of a socket which is configured for engagement with the plug via the plug nut (12) to actuate the plug by rotating the nut. Tightening the plug nut (12) with the plug setting tool (11) will cause the plug to actuate from a non-deployed state to a deployed state, thereby plugging the pipe, and loosening the plug nut (12) with the plug setting tool (11) will cause the plug to actuate from a deployed state to a non-deployed state, thereby unplugging the pipe and allowing withdrawal of the plug therefrom.

The device (5) of FIGS. 1 and 2 additionally comprises a motor (6) in communication with the plug setting tool (11), in this example via reducing gearbox (8). The gearbox, where present, may be used to provide a suitable amount of torque to the plug setting tool to set the plug in place at an appropriate tension. In this example, the gearbox serves to reduce rotating speed and amplify torque transmitted to the plug from the motor (via the plug setting tool), thereby providing more accurate control of the device and allowing for reduced size of the motor and gearbox. The motor (6) is configured to actuate the plug setting tool (11). In this example, the motor (via the output of gearbox (8)) drives clockwise and counter clockwise rotation of the plug setting tool (11), allowing plug nut (12) to be loosened or tightened as desired. Motor (6) is provided with power (i.e. hydraulic input where the motor is a hydraulic motor, electric input where the motor is an electric motor, etc.) and controlled via control cable (9) which extends toward the surface.

The device (5) further includes a supporting member, in the form of spring strip (10), which, in this example, is connected to the plug adaptor (7). The spring strip is a supportive member which can be used to position the plug (1) at a desired location with the pipe (12) either passively (i.e. for a vertical pipe, gravity may be used to bring the plug to the desired location with the spring strip (10) simply preventing the plug from falling down the pipe), or actively (i.e. the spring strip may be used to force the plug through the pipe). The illustrated spring strip is a steel spring strip.

FIGS. 3A-3C depict an embodiment of a plug (1) and plug adaptor (7) employing an example of a reversible attachment via corresponding attachment elements. In this case, the plug (1) comprises two pins with expanded heads (17), and the plug adaptor (7) comprises two corresponding keyhole slots (19) each having an unlocking portion (i.e. the larger cut-out section) and a locking portion (i.e. the smaller cut-out portion). The depicted plug adaptor (7) is attachable to the plug (1) by inserting the pins with expanded heads (17) into the keyhole slots (19) through the unlocking portion and rotating the pins with expanded heads (17) into the locking portion of the keyhole slots (19), and removable from the plug (1) by rotating the pins with expanded heads (17) back into the unlocking portion of the keyhole slots (19) and withdrawing the pins with expanded heads (17) out of the keyhole slots (19). The depicted plug adaptor (7) includes recesses (18) allowing access to the keyhole slots and pins with expanded heads (17). FIGS. 4A-4C depict the plug (1) attached to the plug adaptor (7) in a locked configuration; the plug (1) attached to the plug adaptor (7) in an unlocked configuration reached by rotating the plug adaptor about the plug; and the plug (1) detached from the plug adaptor (7), respectively.

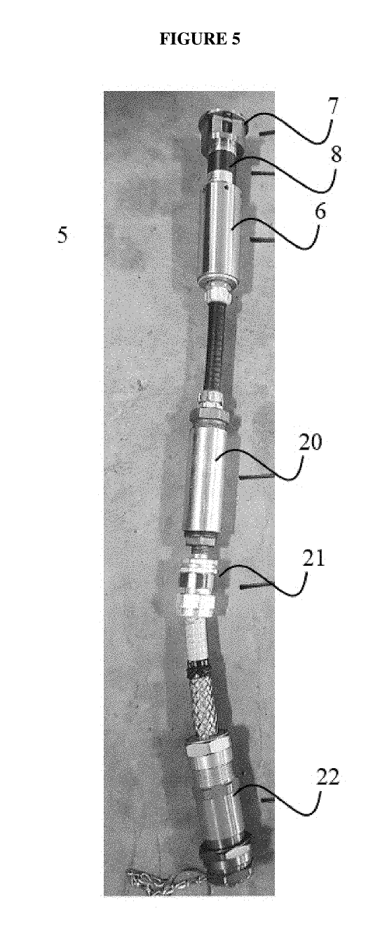

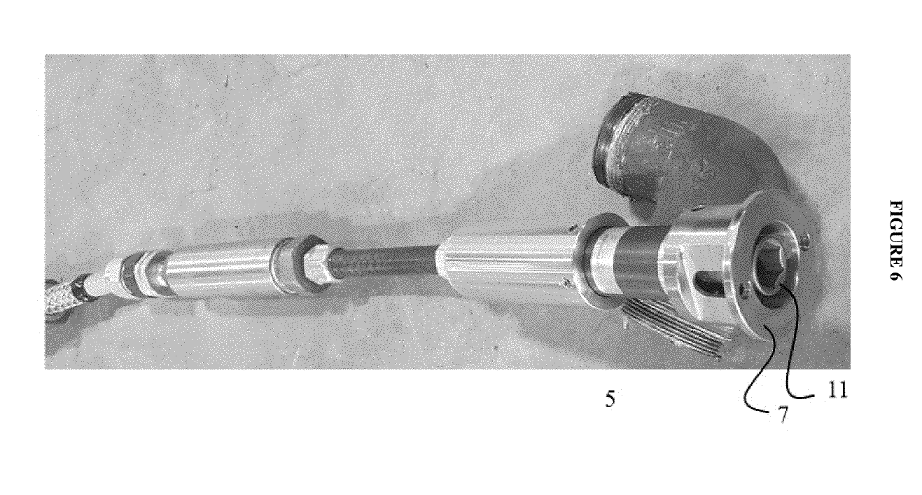

FIGS. 5-8 provide views of another embodiment of a device (5) for setting a plug in a pipe, wherein the device includes an electrical termination housing (20), a teck connector (21), and an electrical connector (22). In this example, these optional components are configured to provide for electrical and mechanical connections of the device controls (these examples being an electrical device version), while maintaining flexibility of the assembly to follow deviations and bends in the pipe. The person of skill in the art having regard to the teachings herein will be aware of a variety of different connection components and configurations which may be employed to suit the particular application and/or device configuration being used, and is not limited to those depicted in this example. FIGS. 6-8 provide close-up views of the plug setting tool (11), which in this example is in the form of a socket for engaging a plug nut (12).

FIGS. 9 and 10 depict device embodiments which comprise a control module (16), in the form of a reel control skid in this example, with the control module (16) comprising:
a control cable reel (13) for controlling feed of the control cable (9);
a spring strip reel (14) for controlling feed of the spring strip (10); and
a controller which operates the control cable reel (13) and the spring strip reel (14), the controller configured to maintain substantially equal feed rate between the control cable (9) and the spring strip (10).

The control module (16) shown in FIGS. 9 and 10 further comprises a power system for supplying the motor with energy to operate via the control cable, a spring strip tensioner (15) for preventing slack on the spring strip reel (14), and an electrical encoder which records rotation of one or both reels, thereby tracking feed of the control cable and/or spring strip to provide a measure of the plug positioning in the pipe during use.

In the device depicted in FIGS. 9 and 10, the torque exerted by the plug setting tool on the plug during actuation thereof is regulated by the control module (16), allowing control over the tension of the plug (1). The torque exerted by the plug setting tool on the plug during actuation thereof is tracked by the control module, and displayed to a user. The control module of the depicted example further comprises a user interface providing controls for operating the device and displaying information concerning plug positioning and/or deployment status.

One or more illustrative embodiments have been described by way of example. It will be understood to persons skilled in the art that a number of variations and modifications can be made without departing from the scope of the invention as defined in the claims.

What is claimed is:

1. A device for setting a plug in a pipe, the device comprising:
a plug adaptor configured for coupling with the plug;
a plug setting tool configured for engagement with the plug to actuate the plug;
a motor in communication with the plug setting tool, the motor configured to actuate the plug setting tool;
a control cable in communication with the motor for controlling operation thereof; and
a supporting member directly or indirectly supporting the plug adaptor, the supporting member configured for positioning the plug in the pipe and optionally comprising a spring strip.

2. The device according to claim 1, further comprising a gearbox between the motor and the plug setting tool.

3. The device according to claim 1, wherein the motor is one of: a hydraulic motor and the control cable supplies a hydraulic fluid to the motor; or an electric motor and the control cable supplies electrical energy to the motor.

4. The device according to claim 1, wherein the plug setting tool is configured to actuate the plug from a non-deployed state to a deployed state, thereby plugging the pipe; to actuate the plug from a deployed state to a non-deployed state, thereby unplugging the pipe and allowing removal of the plug from the pipe; or both.

5. The device according to claim 1, wherein the device is detachable from the plug once the plug is set in the pipe.

6. The device according to claim 1, wherein the device is attachable to a plug which is already set in a pipe.

7. The device according to claim 1, further comprising a camera providing visual information to assist with plugging and/or unplugging the pipe during use of the device.

8. The device according to claim 1, wherein the plug is a compression plug having a top plate and a bottom plate with a compressible plugging material therebetween, and the plug setting tool is configured to actuate the plug from a non-deployed state to a deployed state by causing the top and bottom plates to approach one another, thereby compressing the compressible plugging material causing the compressible plugging material to expand outwardly to set the plug within the pipe.

9. The device according to claim 1, wherein the plug is a compression plug having a top plate and a bottom plate with a compressible plugging material therebetween, and the plug setting tool is configured to actuate the plug from a deployed state to a non-deployed state by causing the top and bottom plates to move away from one another, thereby decompressing the compressible plugging material causing the compressible plugging material to contract inwardly to unset the plug.

10. The device according to claim 1, wherein the plug adaptor is releasable, and configured for reversible attachment with the plug by reversibly engaging one or more corresponding attachment elements of the plug and the plug adaptor and wherein the corresponding attachment elements optionally comprise one or more locking clips; pins with slots formed therein and corresponding holes; pins with expanded heads and corresponding keyhole slots; magnets and corresponding regions of magnetically attracted material or corresponding magnets; or any combination thereof.

11. The device according to claim 10, wherein the plug adaptor is configured for reversible attachment with the plug by reversibly engaging one or more locking clips extending from the top plate of the plug, the plug adaptor, or both, and the plug adaptor being removable from the plug by withdrawing the device from the pipe while the plug is set in the pipe causing the one or more locking clips to detach, wherein the one or more locking clips optionally comprise a pin with a slot formed therein, and the one or more locking clips are engagable through one or more corresponding holes, and wherein the plug adaptor is attachable to the plug by spreading the slots while the pins are passing through the holes, and removable from the plug by pulling the device away from the plug while the plug is set in the pipe causing the slots to narrow.

12. The device according to claim 10, wherein the corresponding attachment elements comprise one or more pins with expanded heads and corresponding keyhole slots having locking and unlocking portions, and wherein the adaptor is attachable to the plug by inserting the pins with expanded heads into the keyhole slots through the unlocking portions and rotating the pins with expanded heads into the locking portions of the keyhole slots, and removable from the plug by rotating the pins with expanded heads back into the unlocking portions of the keyhole slots and withdrawing the pins with expanded heads out of the keyhole slots.

13. The device according to claim 10, wherein the corresponding attachment elements comprise one or more magnets and corresponding regions of magnetically attracted material or corresponding magnets, and wherein the plug adaptor is attachable to the plug by engaging the magnets with the regions of magnetically attracted material or corresponding magnets, and removable from the plug by disengaging the magnets or changing the alignment of the magnets to repel the corresponding magnets

14. The device according to claim 1, further comprising a control module comprising:
a control cable reel for controlling feed of the control cable;
a supporting member reel for controlling feed of the supporting member;
a controller which operates the control cable reel and the supporting member reel;
optionally, a power system for supplying the motor with energy to operate via the control cable; and
optionally, a user interface providing controls for operating the device and displaying information concerning plug positioning and/or deployment status
the controller configured to maintain substantially equal feed rate between the control cable and the supporting member.

15. The device according to claim 14, wherein the control module further comprises a supporting member tensioner for preventing slack on the supporting member reel.

16. The device according to claim 14, wherein the controller of the control module is configured to track feed of the control cable and/or supporting member, thereby providing a measure of the plug positioning within the pipe during use.

17. The device according to claim 16, wherein the control module comprises an electrical encoder which records rotation of one or both reels, thereby tracking feed of the control cable and/or supporting member to provide a measure of the plug positioning in the pipe during use.

18. The device according to claim 14, wherein the supporting member reel controls positioning of the plug within the pipe by dispensing or retracting the supporting member.

19. The device according to claim 14, wherein the torque exerted by the plug setting tool on the plug during actuation thereof is regulated by the control module, allowing control over the tension of the plug.

20. The device according to claim 14, wherein the torque exerted by the plug setting tool on the plug during actuation thereof is tracked by the control module and displayed to a user.
